(19) United States
(12) Patent Application Publication
(10) Pub. No.: US 2004/0039462 A1
(43) Pub. Date: Feb. 26, 2004

(54) Multi-channel wireless professional audio system using sound card

(76) Inventor: Heng-Chien Chen, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,814

(22) Filed: Aug. 21, 2002

(51) Int. Cl. G06F 17/00; H04B 5/00

(52) U.S. Cl. 700/94; 381/79

(57) ABSTRACT

A multi-channel wireless audio system includes a sound card for a computer. The sound card includes a signal broadcasting circuit having a first transceiver for wirelessly transmitting digital audio signals to external speakers, a sound chip electrically connected to the signal broadcasting circuit for processing audio signals sent to the signal broadcasting circuit, and an interface connection for connecting the sound card to the computer. The multi-channel wireless audio system also includes a plurality of wireless speaker modules, each including a second transceiver for receiving the wireless digital audio signals from the signal broadcasting circuit, a digital to analog converter for converting the digital audio signals into analog audio signals, an amplifier for amplifying the analog audio signals, and a speaker for converting the amplified analog audio signals into sound.

### BACKGROUND OF INVENTION

1. Field of the Invention

The present invention relates to a professional audio system, and more specifically, to a professional audio system that uses a sound card to wirelessly transmit multi-channel signals to speakers.

2. Description of the Prior Art

In professional audio systems, a large number of audio channels can be used to output sounds for various input devices. For example, compact disc players output sound in stereo format, which uses two audio channels. The Dolby AC-3 standard outputs 5.1 channels, which includes 5 discrete audio channels plus a low frequency channel. In professional audio systems, audio systems with many audio channels are commonly used, and each of the audio channels can be sent to a unique speaker for output. When a computer sound card is used in an audio system, a sound chip in the sound card processes audio signals, and outputs the audio signals in the form of a number of audio channels. Each of these audio channels can then be sent to a speaker through a cable going from the sound card to each speaker. Any number of audio channels and corresponding speakers can be used with the sound card. Sound cards that can accommodate 2 channel, 5.1 channel, or 7.1 channel systems are commonly found.

Please refer to FIG. 1. FIG. 1 is a block diagram of a wired professional audio system 10 according to the prior art. A sound card 12 is connected to a plurality of speakers 14, which are positioned in various locations around a room. For example, FIG. 1 shows a front left speaker 14 and a rear right speaker 14. These speakers 14 are stated as an example only, and any number of speakers 14 can be used. Typically, one speaker 14 is used for each channel provided by the wired professional audio system 10. In addition to the speakers 14, the sound card 12 can also be connected to a joystick 16 and to a microphone 18, as is well known in the art.

Unfortunately, not only does the setup for the wired professional audio system 10 require a large number of cables connected to the sound card 12, but it also makes connecting the speakers 14, the joystick 16, and the microphone 18 much more troublesome. Care has to be taken to make sure speaker cables are positioned out of the way to allow easy movement around the wired professional audio system 10. Moreover, if one of the speakers 14 is to be moved, care must be taken to ensure that the corresponding speaker cable is long enough to reach the new location of the speaker 14. Speaker cables used in professional audio systems are very expensive, and can be 30 to 100 meters long. Moreover, speaker cables have to be carefully designed so that audio output is not affected by RLC characteristics of the cables. For example, suppose that a speaker has a power rating of 1000W with a resistance of 8 Ω. That means that the speaker cable leading to each speaker would have a high amount of current being carried through it. Since the frequency response for the speaker is desired to be above 20 kHz, that means that the total resistance of the speaker cable (including the two ends) has to be less than 1 Ω. Unfortunately, undesirable RLC effects of the speaker cable can affect the quality of the audio output, and adversely affect the frequency response.

### SUMMARY OF INVENTION

It is therefore a primary objective of the claimed invention to provide a multi-channel wireless audio system in order to solve the above-mentioned problems.

According to the claimed invention, a multi-channel wireless audio system includes a sound card for a computer. The sound card includes a signal broadcasting circuit having a first transceiver for wirelessly transmitting digital audio signals to external speakers, a sound chip electrically connected to the signal broadcasting circuit for processing audio signals sent to the signal broadcasting circuit, and an interface connection for connecting the sound card to the computer. The audio system also has a plurality of wireless speaker modules, each including a second transceiver for receiving the wireless digital audio signals from the signal broadcasting circuit, a digital to analog converter for converting the digital audio signals into analog audio signals, an amplifier for amplifying the analog audio signals, and a speaker for converting the amplified analog audio signals into sound.

It is an advantage of the claimed invention that the multi-channel wireless audio system does not need speaker cables to connect speakers to the sound card. This makes positioning the speakers much easier, and no speaker cables have to be hidden out of the way. Speakers can easily be moved to new positions without worrying about the length of speaker cables. Additionally, wirelessly broadcasting digital signals eliminates the need for expensive speaker cables that can adversely affect audio output characteristics, and wireless transmission does not lead to audio quality degradation.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a wired professional audio system according to the prior art.

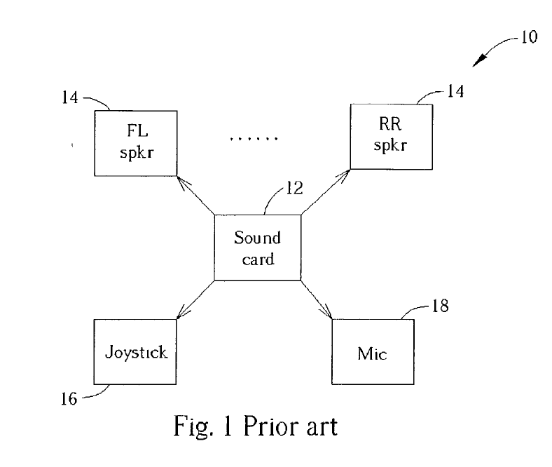

FIG. 2 is a block diagram of a wireless professional audio system according to the present invention.

FIG. 3 is a functional block diagram of a sound card of the wireless professional audio system.

FIG. 4 is a functional block diagram of a single channel speaker module used in the wireless professional audio system.

FIG. 5 is a functional block diagram of a multi-channel speaker module used in the wireless professional audio system.

FIG. 6 is a functional block diagram of a joystick and a joystick adapter according to the present invention.

FIG. 7 is a functional block diagram of a microphone and a microphone adapter according to the present invention.

### DETAILED DESCRIPTION

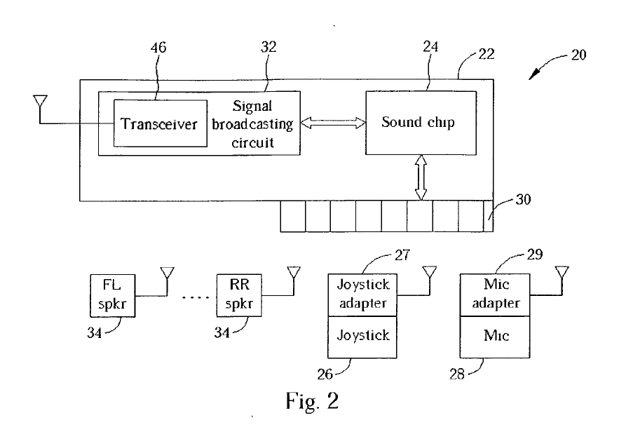

Please refer to FIG. 2. FIG. 2 is a block diagram of a wireless professional audio system 20 according to the present invention. A sound card 22 contains an interface 30, such as a PCI bus interface 30, for interfacing with a host computer. A sound chip 24 is connected to the interface 30, and is capable of processing sound and joystick signals. A signal broadcasting circuit 32 is connected to the sound chip 24, and is used to wirelessly send multiple audio channels to corresponding speaker modules 34. The signal broadcasting circuit 32 is also used to send and receive signals to and from a joystick 26, and to receive signals from a microphone 28. In the present invention, a joystick adapter 27 can be used to enable joystick 26 to be used to send and receive wireless signals to and from the signal broadcasting circuit 32. Likewise, the microphone 28 can be outfitted with a microphone adapter 29 so that audio signals produced by the microphone can be wirelessly transmitted to the signal broadcasting circuit 32.

As with the example described in the prior art, the following description will assume that the wireless professional audio system 20 uses a plurality of audio channels and corresponding speaker modules 34. Of course, the present invention can easily be extended to include any number of audio channels used in a professional audio system. With the present invention, the signal broadcasting circuit 32 receives audio signals from the sound chip 24, and uses a transceiver 46 to wirelessly broadcast these audio signals to all speaker modules 34. As will be described later, each speaker module 34 only produces sound generated by the audio channel corresponding to that speaker module 34.

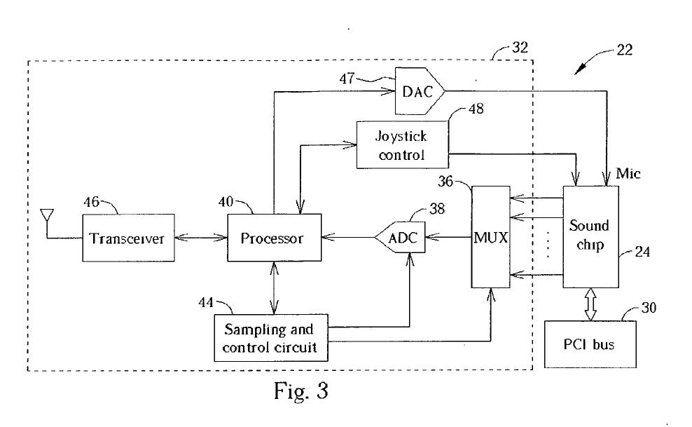

Please refer to FIG. 3. FIG. 3 is a functional block diagram of the sound card 22 of the wireless professional audio system 20. The sound chip 24 mixes audio signals, and separates the signals into distinct audio channels. Audio signals from each of the audio channels are then fed from the sound chip 24 into a multiplexer 36. To minimize the complexity of the signal broadcasting circuit 32, the multiplexer is used to select one audio channel at a time for processing and transmission. A sampling and control circuit 44 is used to select one of the inputted audio channels to be outputted from the multiplexer 36. Signals from the selected audio channel are then converted into digital signals via an analog-to-digital converter (ADC) 38. Operation of the ADC 38 is also controlled by the sampling and control circuit 44. Digital audio signals are then sent from the ADC 38 to a processor 40 so that the signals can be appropriately packaged and compressed for wireless transmission, and the sampling and control circuit 44 helps to control operation of the processor 40. Finally, the processor 40 sends the digital signals to the transceiver 46 for wireless transmission to the speaker modules 34. During the packaging operation, a unique channel identifier is put into the packaged signals to denote which channel signal is being transmitted.

In addition to outputting audio signals to speakers, the signal broadcasting circuit 32 is also used to receive audio signals from the microphone 28. In this case, the transceiver 46 receives a digital form of the microphone 28 audio signals, and sends the signals to the processor 40. The processor 40 then sends the digital audio signals to a digital-to-analog converter (DAC) 47, which converts the microphone 28 signals into analog signals. Finally, the analog signals are sent to the sound chip 24 for proper processing of the microphone 28 audio signals.

Likewise, the present invention sound card 22 is also capable of receiving control signals from the joystick 26, and sending feedback signals back to the joystick 26. When the sound card 22 receives control signals from the joystick 26, the transceiver 46 sends the signals to the processor 40. The processor 40 then sends these signals to a joystick control circuit 48 for proper processing of the signals from the joystick 26. Finally, the processed control signals are then sent to the sound chip 24, and the sound chip 24 can send control signals to the host computer through the PCI interface 30. On the other hand, the host computer is capable of sending feedback signals to the joystick 26 by sending the signals through the opposite direction. In this case, the feedback signals would first be sent to the PCI bus interface 30, the sound chip 24, the joystick control circuit 48, and the processor 40. The processor 40 would then append an identifying code to the joystick feedback signals so that the joystick will be able to determine that the joystick is the appropriate target of the signals. Finally, the processor 40 sends the signals to the transceiver 46 for transmission to the joystick 26.

Although the joystick 26 and all speaker modules 34 will receive the transmitted wireless signals, only devices with a proper identifying code will be able to process signals containing this code. In order to broadcast signals for all audio channels to the speaker modules 34, the sampling and control circuit 44 will take turns selecting different audio channels to be output from the multiplexer 36. Moreover, the switching and transmission of each different audio channel is done quickly so that all audio channels can be broadcast to all speaker modules 34 in real time. In this way, all audio channels can be wirelessly transmitted to all speakers in the wireless professional audio system 20. Likewise, whenever feedback signals need to be sent to the joystick 26, the sampling and control circuit 44 will take turns between sending these feedback signals to the joystick 26 and sending audio signals to the speakers 34.

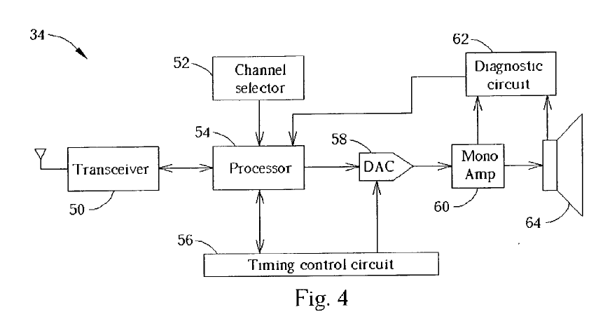

Please refer to FIG. 4. FIG. 4 is a functional block diagram of a single channel speaker module 34 used in the wireless professional audio system 20. The basic structure of each speaker module 34 in the wireless professional audio system 20 is identical, so FIG. 4 can be used to represent each of the speaker modules 34. A transceiver 50 is used to receive all wireless digital signals transmitted by the transceiver 46 of the signal broadcasting circuit 32, and these signals are then sent to a processor 54 for appropriate processing. The processor 54 will then compare the channel identifier included in the received signals with a channel identifier stored in a channel selector 52. If the identifier does not match, the speaker module 34 does no further processing on the received signals. If there is a match, the received digital signals are then sent to a digital-to-analog converter (DAC) 58 for conversion back into analog signals. A timing control circuit 56 communicates with the processor 54, and helps control timing for operation of the processor 54 and the DAC 58. Analog signals produced by the DAC 58 are then sent to a mono amplifier 60 for amplification before being sent to a speaker 64 that converts the amplified analog signals into sound. A diagnostic circuit 62 is used to notify the processor 54 of any problems that are detected in the operation of the mono amplifier 60 and the speaker 64.

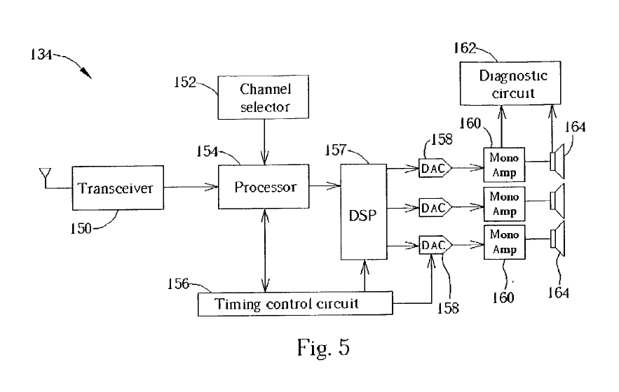

The speaker module 34 shown in FIG. 4 is a single channel speaker, meaning that it is only capable of playing sounds from one audio channel. Please refer to FIG. 5. FIG. 5 is a functional block diagram of a multi-channel speaker module 134 used in the wireless professional audio system 20. Operation of the multi-channel speaker module 134 is nearly identical to operation of the speaker module 34 shown in FIG. 4. The only difference is the addition of more channels to the speaker. As an example, the multi-channel speaker module 134 shown in FIG. 5 is a three-channel speaker, which produces low, medium, and high frequency sounds, but any number of channels could be used in the present invention.

A transceiver 150 is used to receive all wireless digital signals transmitted by the signal broadcasting circuit 32, and these signals are then sent to a processor 154 for processing. The processor 154 will then compare the channel identifier included in the received signals with a set of channel identifiers stored in a channel selector 152. If the identifier does not match, the multi-channel speaker module 134 does no further processing on the received signals. If there is a match, the received digital signals are then sent to a DSP 157 for signal processing. Based on the channel identifier included with the received signals, the DSP 157 then sends the signals to one of three digital-to-analog converters (DACs) 158 for conversion back into analog signals. A timing control circuit 156 communicates with the processor 154, and helps control timing for operation of the processor 154 and the DACs 158. Analog signals produced by each DAC 1158 are then sent to a corresponding mono amplifier 160 for amplification before being sent to a corresponding speaker 164 that converts the amplified analog signals into sound. A diagnostic circuit 162 is used to notify the processor 154 of any problems that are detected in the operation of the mono amplifiers 160 and the speakers 164.

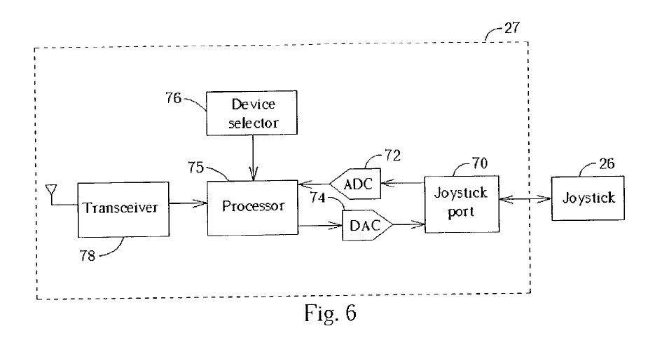

Please refer to FIG. 6. FIG. 6 is a functional block diagram of the joystick 26 and the joystick adapter 27 according to the present invention. The present invention uses the joystick adapter 27 so that a conventional joystick such as the joystick 26 can be used to wirelessly transmit to and receive control signals from the sound card 22. The joystick adapter 27 contains a joystick port 70 for plugging the joystick 26 into the joystick adapter 27. When the joystick 26 transmits control signals to the sound card 22, the control signals are sent through the joystick port 70 to an ADC 72 for conversion into digital signals. The digital signals are then sent to a processor 75 for packaging, and then transmitted by a transceiver 78 to the signal broadcasting circuit 32 of the sound card 22. On the other hand, when the joystick adapter 27 receives feedback signals from the sound card 22, these signals are first received by the transceiver 78 and then sent to the processor 75. The processor 75 will then check an identification code embedded in the feedback signals to see if the code matches an identification code stored in a device selector 76. If the codes do not match, the joystick adapter 27 does nothing. If the codes do match, the processor 75 transmits the feedback signals to a DAC 74 for conversion into analog signals. These analog signals are then sent through the joystick port 70 to the joystick 26. Thus, the joystick 26 can maintain bidirectional wireless communication with the sound card 22 through the use of the joystick adapter 27.

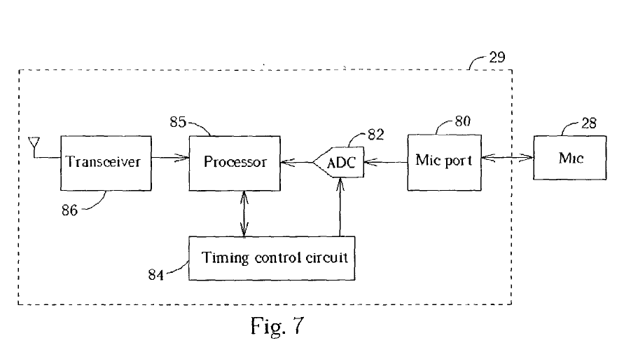

Please refer to FIG. 7. FIG. 7 is a functional block diagram of the microphone 28 and the microphone adapter 29 according to the present invention. The present invention uses the microphone adapter 29 so that a conventional microphone such as the microphone 28 can be used to wirelessly transmit audio signals to the sound card 22. The microphone adapter 29 contains a microphone port 80 for plugging the microphone 28 into the microphone adapter 29. When the microphone 28 transmits audio signals to the sound card 22, the audio signals are sent through the microphone port 80 to an ADC 82 for conversion into digital signals. The digital signals are then sent to a processor 85 for packaging, and then transmitted by a transceiver 86 to the signal broadcasting circuit 32 of the sound card 22. A timing control circuit 84 communicates with the processor 85, and helps control timing for operation of the processor 85 and the ADC 82. Thus, the microphone 28 can wirelessly transmit audio signals to the sound card 22 through the use of the microphone adapter 29.

In a preferred embodiment of the present invention, all wireless signals used in communication between the transceiver of the signal broadcasting circuit and the transceivers of the speaker modules, the joystick, and the microphone are direct sequence spread spectrum (DSSS) signals that conform to the IEEE 802.11b networking standard.

Compared to the prior art, the wireless professional audio system is able to send audio signals from the signal broadcasting circuit of the sound card to speaker modules via wireless transmission, eliminating the need for speaker cables to connect audio processing circuitry with speakers. In addition, the present invention sound card can also be used to support a wireless microphone and a wireless joystick. Transceivers are used in the speaker modules, the joystick, the microphone, and the signal broadcasting circuit of the sound card to facilitate the wireless communication. The flexibility that wireless transmission provides makes positioning the speakers much easier, and speakers can easily be moved to new positions without worrying about the constraint of speaker cables. Additionally, wirelessly broadcasting digital signals eliminates the need for expensive speaker cables that can adversely affect audio output characteristics, and wireless transmission does not lead to audio quality degradation.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A multi-channel wireless audio system comprising:
a sound card for a computer, the sound card comprising:
a signal broadcasting circuit having a first transceiver for wirelessly transmitting digital audio signals to external speakers;
a sound chip electrically connected to the signal broadcasting circuit for processing audio signals sent to the signal broadcasting circuit; and
an interface connection for connecting the sound card to the computer; and
a plurality of wireless speaker modules each comprising:
a second transceiver for receiving the wireless digital audio signals from the signal broadcasting circuit;
a digital to analog converter for converting the digital audio signals into analog audio signals;
an amplifier for amplifying the analog audio signals; and
a speaker for converting the amplified analog audio signals into sound.

2. The audio system of claim 1 wherein the signal broadcasting circuit further comprises a multiplexer having a plurality of input nodes and one output node, each input node being used to receive audio signals of an audio channel from the sound chip, the output node being used for outputting audio signals of a selected audio channel, and an analog to digital converter for converting the audio signals of the selected audio channel into digital audio signals.

3. The audio system of claim 1 wherein the signal broadcasting circuit further comprises a packaging and compressing circuit for compressing the digital audio signals outputted from the analog to digital converter and dividing the signals into packages before wireless transmission by the first transceiver.

4. The audio system of claim 1 wherein the signal broadcasting circuit further comprises a sampling and control circuit for controlling operation of the multiplexer and the analog to digital converter.

5. The audio system of claim 1 wherein each wireless speaker module further comprises a processor for controlling operation of the wireless speaker module.

6. The audio system of claim 5 wherein each wireless speaker module further comprises a channel selector for identifying a selected audio channel, and the processor of the wireless speaker module processes only those digital audio signals corresponding to the selected audio channel.

7. The audio system of claim 5 wherein each wireless speaker module further comprises a diagnostic circuit for detecting performance problems in the amplifier and the speaker, and for notifying the processor of any problems.

8. The audio system of claim 1 wherein each wireless speaker module further comprises a timing control circuit for controlling timing of the digital to analog converter.

9. The audio system of claim 1 wherein the wireless digital signals transmitted from the signal broadcasting circuit to the plurality of wireless speaker modules are direct sequence spread spectrum signals and conform to the IEEE 802.11b networking standard.

10. The audio system of claim 1 wherein the sound chip of the sound card comprises a joystick input port for receiving control signals from a joystick and a microphone input port for receiving audio signals from a microphone.

11. A multi-channel wireless audio system comprising:
a sound card for a computer, the sound card comprising:
a signal broadcasting circuit having a first transceiver for wirelessly transmitting digital audio signals to external speakers;
a sound chip electrically connected to the signal broadcasting circuit for processing audio signals sent to the signal broadcasting circuit; and
an interface connection for connecting the sound card to the computer; and
at least one multi-channel wireless speaker module comprising:
a second transceiver for receiving the wireless digital audio signals from the signal broadcasting circuit;
a plurality of digital to analog converters for converting digital audio signals into analog audio signals;
a plurality of amplifiers for amplifying the analog audio signals; and
a plurality of speakers for converting the amplified analog audio signals into sound.

12. The audio system of claim 11 wherein the signal broadcasting circuit further comprises a multiplexer having a plurality of input nodes and one output node, each input node being used to receive audio signals of an audio channel from the sound chip, the output node being used for outputting audio signals of a selected audio channel, and an analog to digital converter for converting the audio signals of the selected audio channel into digital audio signals.

13. The audio system of claim II wherein the signal broadcasting circuit further comprises a packaging and compressing circuit for compressing the digital audio signals outputted from the analog to digital converter and dividing the signals into packages before wireless transmission by the first transceiver.

14. The audio system of claim 111 wherein the signal broadcasting circuit further comprises a sampling and control circuit for controlling operation of the multiplexer and the analog to digital converter.

15. The audio system of claim 11 wherein each wireless speaker module further comprises a processor for controlling operation of the wireless speaker module.

16. The audio system of claim 15 wherein each wireless speaker module further comprises a channel selector for identifying a plurality of selected audio channels, and the processor of the wireless speaker module processes only those digital audio signals corresponding to the selected audio channels.

17. The audio system of claim 15 wherein each wireless speaker module further comprises a diagnostic circuit for detecting performance problems in the amplifiers and the speakers, and for notifying the processor of any problems.

18. The audio system of claim 11 wherein the wireless digital signals transmitted from the signal broadcasting circuit to the plurality of wireless speaker modules are direct sequence spread spectrum signals and conform to the IEEE 802.11b networking standard.

19. The audio system of claim 11 wherein the sound chip of the sound card comprises a joystick input port for receiving control signals from a joystick and a microphone input port for receiving audio signals from a microphone.

20. A multi-channel wireless audio system comprising:
a sound card for a computer, the sound card comprising:
a signal broadcasting circuit comprising:
a first transceiver for wirelessly transmitting digital audio signals to external speakers;
a multiplexer having a plurality of input nodes and one output node, each input node being used to receive audio signals of an audio channel from the sound chip, the output node being used for outputting audio signals of a selected audio channel; and
an analog to digital converter for converting the audio signals of the selected audio channel into digital audio signals;
a sound chip electrically connected to the signal broadcasting circuit for processing audio signals sent to the signal broadcasting circuit; and
an interface connection for connecting the sound card to the computer; and
a plurality of wireless speaker modules comprising:
a second transceiver for receiving the wireless digital audio signals from the signal broadcasting circuit;
a digital to analog converter for converting the digital audio signals into analog audio signals;
an amplifier for amplifying the analog audio signals; and
a speaker for converting the amplified analog audio signals into sound.
